(19) United States
(12) Patent Application Publication
(10) Pub. No.: US 2025/0307371 A1
(43) Pub. Date: Oct. 2, 2025

(54) VEHICLE AND VERIFICATION SYSTEM

(71) Applicant: TOYOTA JIDOSHA KABUSHIKI KAISHA, Toyota-shi Aichi-ken (JP)

(72) Inventors: Yusuke HAYASHI, Atsugi-shi Kanagawa-ken (JP); Taichi KAWANAI, Shizuoka-shi Shizuoka-ken (JP); Sadayuki ABE, Sunto-gun Shizuoka-ken (JP); Daichi HOTTA, Meguro-ku Tokyo-to (JP)

(73) Assignee: TOYOTA JIDOSHA KABUSHIKI KAISHA, Toyota-shi Aichi-ken (JP)

(21) Appl. No.: 19/088,444

(22) Filed: Mar. 24, 2025

(30) Foreign Application Priority Data
Mar. 28, 2024 (JP) 2024-054802

(51) Int. Cl. G06F 21/33

(52) U.S. Cl. CPC G06F 21/33

(57) ABSTRACT

A vehicle includes a first control device including in-vehicle software and a second control device designed to be limitedly accessible by a specific administrator. The first control device and the second control device can communicate with each other. The second control device is configured to store a verification key for verifying validity of instruction information and perform instruction verification to verify the validity of the instruction information using the verification key. The first control device does not include the verification key.

### CROSS-REFERENCE TO RELATED APPLICATION

This application claims priority to Japanese Patent Application No. 2024-054802 filed on Mar. 28, 2024, the entire contents of which are incorporated by reference herein.

### TECHNICAL FIELD

The present disclosure relates to a technique for verifying validity of information using a verification key.

### BACKGROUND ART

Patent Literature 1 discloses a technique for enhancing the flexibility of reprogramming of a secure area. Secure writing software in ECU that has received a request to start reprogramming verifies a signature of update data stored in a repro data storage unit using a key. If the result of the verification is correct, the secure writing software rewrites a program.

### LIST OF RELATED ART

Patent Literature 1: International Patent Publication No. WO 2020/090418

### SUMMARY

A case of verifying validity of information using a verification key is considered. If the verification key for security is tampered with, unauthorized data may be erroneously determined to be valid. In particular, the inhibition of correct information transmission for vehicles may lead to serious accidents or troubles.

The present disclosure aims to provide a technique making the verification key less likely to be tampered with than in the related art and enhancing information security.

A first aspect relates to a vehicle.

The vehicle includes:
a first control device including in-vehicle software; and
a second control device designed to be limitedly accessible by a specific administrator.

The first control device and the second control device can communicate with each other.

The second control device is configured to:
store a verification key for verifying validity of instruction information transmitted from outside of the second control device, the verification key being provided from the specific administrator in advance; and
perform instruction verification to verify the validity of the instruction information using the verification key.

The first control device does not include the verification key.

A second aspect further includes the following feature in addition to the first aspect.

The in-vehicle software included in the first control device is designed to be rewritable by one or more users.

The specific administrator includes a vehicle provider that provides the vehicle to the one or more users.

A third aspect relates to a verification system for verifying instruction information for operating a target device.

The verification system includes:
a first control device, including software, provided with the target device; and
a second control device designed to be limitedly accessible by a specific administrator.

The first control device and the second control device can communicate with each other.

The second control device is configured to:
store a verification key to verify validity of instruction information transmitted from outside of the second control device, the verification key being provided from the specific administrator in advance; and
perform instruction verification to verify the validity of the instruction information using the verification key.

The first control device does not include the verification key.

According to the first aspect, the in-vehicle software installed in the vehicle is stored in the first control device, and the verification key is stored in the second control device. The in-vehicle software and the verification key are stored in the different control devices. Only the second control device, which is limitedly accessible, can verify the validity of the instruction information. Therefore, the information security of the vehicle is higher than in the case where both (i.e., the in-vehicle software and the verification key) are stored in one control device.

According to the second aspect, the in-vehicle software included in the first control device is designed to be rewritable by one or more users. The second control device is designed to be limitedly accessible by a vehicle provider who provides a vehicle to one or more users. Therefore, when a user rewrites a verification key related to his/her software, the user, in principle, does not intentionally or erroneously rewrite (tamper) the verification key related to other users, and thus, even when the vehicle is shared, the information security is kept high.

According to the third aspect, the verification system for verifying the instruction information for operating the target device includes a first control device, including software and installed in the target device, and a second control device designed to be limitedly accessible by a specific administrator. That is, the information security as shown in the first and second aspects can be realized to other than vehicles.

### BRIEF DESCRIPTION OF DRAWINGS

FIG. 1 is a diagram showing a comparison example of a vehicle equipped with software;

FIG. 2 is a diagram showing an outline of a vehicle according to the present embodiment;

FIG. 3 is a block diagram showing an example of instruction verification when instruction information is update data of in-vehicle software;

FIG. 4 is a block diagram showing an example of the instruction verification in the case where the instruction information is an instruction transmitted from the in-vehicle software;

FIG. 5 is a block diagram showing an example of the instruction verification when the instruction information is an instruction by cooperative software cooperating with the in-vehicle software;

FIG. 6 is a block diagram showing another example of the instruction verification when the instruction information is an instruction by the cooperative software cooperating with the in-vehicle software;

FIG. 7 is a flowchart showing a main flow of process related to the instruction verification;

FIG. 8 is a diagram showing a concept of a “vehicle platform” according to the present embodiment;

FIG. 9 is a block diagram showing an example of a configuration of a vehicle used in the vehicle platform;

FIG. 10 is a diagram showing an example of user verification based on user information transmitted from the in-vehicle software;

FIG. 11 is a diagram showing an example of the user verification in cooperation with a scheduler;

FIG. 12 is a diagram showing an example of a method for authenticating a user having valid authority without using a user verification key;

FIG. 13 is a flowchart showing a main flow of process related to the user verification;

FIG. 14 is a diagram illustrating an overview of cooperation permission for cooperative software;

FIG. 15 is a diagram illustrating a specific example of the cooperation permission for the cooperative software;

FIG. 16 is a diagram illustrating another specific example of the cooperation permission for the cooperative software.

### DETAILED DESCRIPTION

Embodiments of the present disclosure will be described with reference to the accompanying drawings.

### 1. Overview

A software-installed vehicle will be considered.

An example of the software installed in the vehicle is autonomous driving software. The autonomous driving software performs autonomous driving of the vehicle. Here, the autonomous driving means that at least a part of steering, acceleration, and deceleration of the vehicle is automatically performed independently of an operation of the occupant. The autonomous driving software transmits information to a traveling device (a driving device, a brake, a steering, etc.) of the vehicle to control traveling of the vehicle. A vehicle provided with autonomous driving software is referred to as an autonomous driving vehicle.

If the vehicle is under the control of a remote support system, the vehicle is provided with software for communicating with the remote support system. The remote support refers to all interventions on the target vehicle performed by a remote supporter being away from the target vehicle through communication. The remote support is a concept including remote monitoring, remote assistance, and remote driving. The remote monitoring includes monitoring of the surrounding environment of the target vehicle, the vehicle state of the target vehicle, the state of the occupant of the target vehicle, etc. The remote assistance refers to an instruction given by the remote supporter regarding the traveling of the target vehicle when a support request is received from the target vehicle. For example, when the autonomous driving vehicle as the target vehicle cannot determine a safe timing as start, lane change, right or left turn, etc, the autonomous driving vehicle transmits a support request to the remote support system. The remote supporter that has received the support request instructs the autonomous driving vehicle to perform appropriate timing. The remote driving refers to driving of the target vehicle by controlling a traveling device of the target vehicle based on an operation input to a terminal for remote driving by the remote supporter.

When the vehicle is under the management of an operation management system, the vehicle includes in-vehicle software for communicating with the operation management system. The operation management system mainly manages the operation of vehicles in an area where a plurality of autonomous driving vehicles and remote support target vehicles travel. The operation management system, for example, adjusts delivery routes among a plurality of delivery vehicles, or selects an optimal vehicle to be headed to a site when a vehicle allocation service is requested.

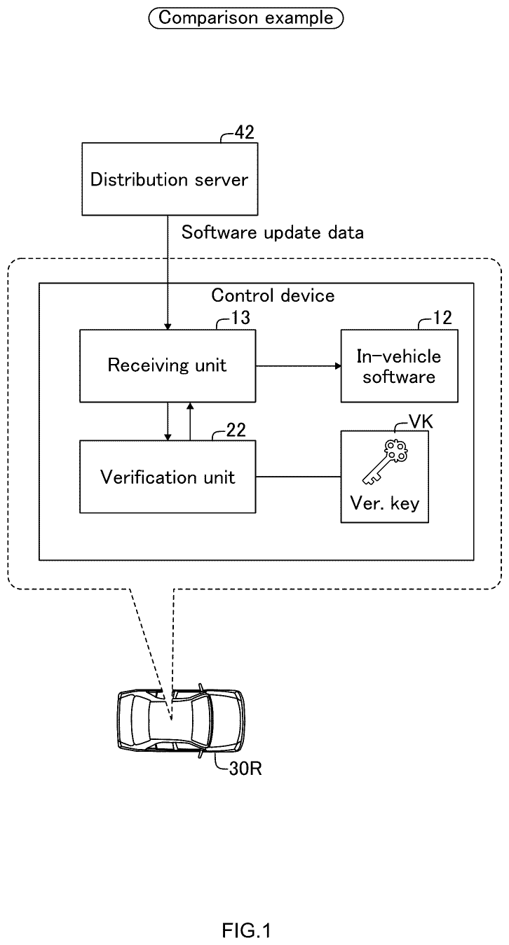

FIG. 1 is a diagram showing a software-installed vehicle 30R as a comparative example. The in-vehicle software 12 is installed in a control device provided in the vehicle 30R. The same control device stores a verification key VK for verifying the validity of information from the outside. For example, when the in-vehicle software 12 is updated, software update data is transmitted from the distribution server 42. The control device receives the update data by a receiving unit 13, and a verification unit 22 determines whether to accept the update data as information from the outside as valid data by using a verification key VK. When the update data is determined to be valid, the control device updates the in-vehicle software 12. On the other hand, when determining that the update data is invalid, the control device regards the update data as invalid and rejects the update data. As described above, a mechanism for excluding unauthorized access by using the verification key VK is known. The verification key is abbreviated to “ver. key” in the drawings.

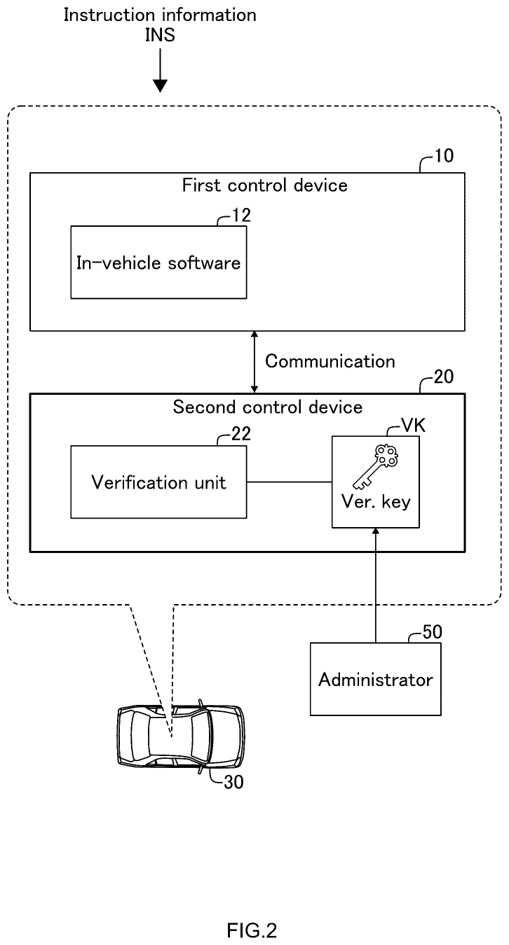

FIG. 2 is a diagram showing an overview of a vehicle 30 according to the present embodiment. The vehicle 30 includes a first control device 10 and a second control device 20. The first control device 10 stores in-vehicle software 12. The second control device 20 stores a verification key VK. The first control device 10 and the second control device 20 can communicate with each other. Only a specific administrator 50 having access permission is allowed to access the second control device 20. The verification key VK is stored in the second control device 20 by the administrator 50. Another feature of the vehicle 30 is that the first control device 10 does not include the verification key VK. In the present embodiment, the term “access” means an action of reading or rewriting information stored in a specific area. On the other hand, the term “communication” means that a transmission side and a reception side exchange information in accordance with a predetermined communication protocol, distinguished from “access” in that reading and rewriting information are not involved.

Tampering with the verification key VK by a third party will be considered. If the verification key VK is tampered with, unauthorized data that may be erroneously determined to be valid. Conversely, authorized data may be determined as invalid data and rejected. In vehicles, the inhibition of proper information transmission may lead to serious accidents or troubles. Therefore, it is important to take measures against tampering with the verification key VK. The verification key VK is generally protected to exclude unauthorized access.

As shown in the comparative example of FIG. 1, when the verification key VK is stored in the same control device where the in-vehicle software 12 is stored, for example when the in-vehicle software 12 is updated, access from the distribution server 42 to the control device (that is, the area including the verification key VK) is permitted. In other words, the in-vehicle software 12 operating in the vehicle 30R and the verification key VK for security are “close” to each other.

On the other hand, in the vehicle 30 in FIG. 2, the in-vehicle software 12 and the verification key VK are stored in the different control devices. Further, since the second control device 20 including the verification key VK is designed to be limitedly accessible by the administrator 50, it is possible to restrict access to the verification key VK by a third person (other than the administrator 50), in principle. In other words, the in-vehicle software 12 and the verification key VK for security are “far” from each other. The information security of the vehicle 30 shown in FIG. 2 is higher than that of the vehicle 30R shown in FIG. 1, because the in-vehicle software 12 and the verification key VK are stored in the different control devices.

The configuration of the vehicle 30 is effective not only in updating the in-vehicle software 12 but also against general unauthorized access from the outside of the vehicle 30. A case where the vehicle 30 receives “instruction information INS” from the outside is considered. The instruction information INS includes general instructions to the vehicle 30. The update data INS-1 for instructing the update of the in-vehicle software 12 is an example of the instruction information INS. The second control device 20 executes “instruction verification” to verify the validity of the instruction information INS using the verification key VK. Hereinafter, some examples of the instruction information INS and the instruction verification will be described.

### 2. Instruction Verification

### 2-1. Example of Instruction Information to be Subject to Instruction Verification

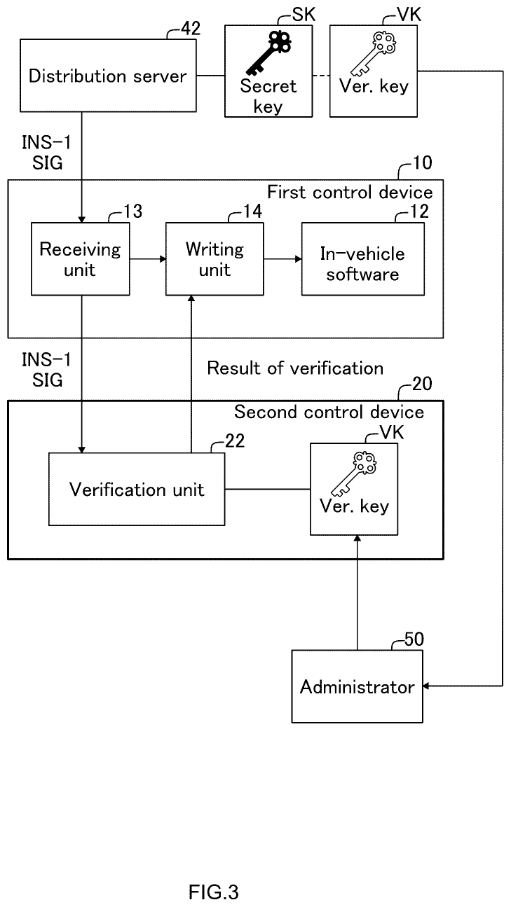

FIG. 3 is a block diagram showing an example of instruction verification in a case where the instruction information INS is update data (hereinafter, referred to as “update data INS-1”) of the in-vehicle software 12.

The update data INS-1 is transmitted from the distribution server 42 to the receiving unit 13 in the first control device 10. At this time, the update data INS-1 is transmitted together with a digital signature SIG generated based on a secret key SK. For example, the digital signature SIG is generated based on the update data INS-1 and the secret key SK. The secret key SK corresponds to the verification key VK stored in the second control device 20, and the digital signature SIG generated based on the secret key SK can be decrypted only with the corresponding verification key VK. The verification key VK is provided in advance from the distribution server 42 to the administrator 50, and is stored in the second control device 20 by the administrator 50.

The receiving unit 13 transmits the digital signature SIG and the update data INS-1 to the verification unit 22 in the second control device 20. The second control device 20 verifies the validity of the update data INS-1 by decrypting the digital signature SIG using the verification key VK stored in the second control device 20. Hereinafter, such a process of verifying the validity of the instruction information INS is referred to as “signature verification”. The signature verification comprises decrypting the digital signature SIG encrypted using the secret key SK, using the verification key VK stored in the second control device 20. The signature verification is an example of the instruction verification.

The second control device transmits the result of the instruction verification (valid/invalid) to the first control device 10. When the result of the instruction verification is valid, a writing unit 14 of the first control device 10 updates the in-vehicle software 12 using the update data INS-1. On the other hand, when the result of the instruction verification is invalid, the first control device 10 rejects the update data INS-1 and does not update the in-vehicle software 12.

Here, the signature verification may be a method using a hash function and a hash value. The hash function is a function for converting input data into a fixed-length numerical value. The hash value is the numerical value obtained from the hash function. For example, SHA-1 (square hash algorithm 1), which is a hash function commonly used, generates a hash value of 160 bits (40 digits in hexadecimal) regardless of the length of input data. The hash function outputs the same hash value if the input data is identical. On the other hand, if the input data is different even slightly, the hash function outputs a completely different hash value. It is known to be extremely difficult to intentionally generate different data having the same hash value or to restore original data from the hash value. Therefore, the second control device 20 can execute signature verification with high confidentiality on the update data INS-1 by using the hash value unique to the electronic data as described below.

First, the distribution server 42 generates a hash value of the update data INS-1, and generates the digital signature SIG based on the hash value and the secret key SK. The first control device 10 that has received the update data INS-1, and the digital signature generates a hash value of the update data INS-1 and transmits the hash value to the second control device 20 together with the digital signature SIG. The second control device 20 obtains a hash value from the digital signature SIG using the verification key VK. When the hash value obtained by the verification key VK and the hash value generated from the update data INS-1 itself match, the second control device 20 can determine that the digital signature SIG has been transmitted from the distribution server 42 having the secret key SK and has not been tampered with since data transmission.

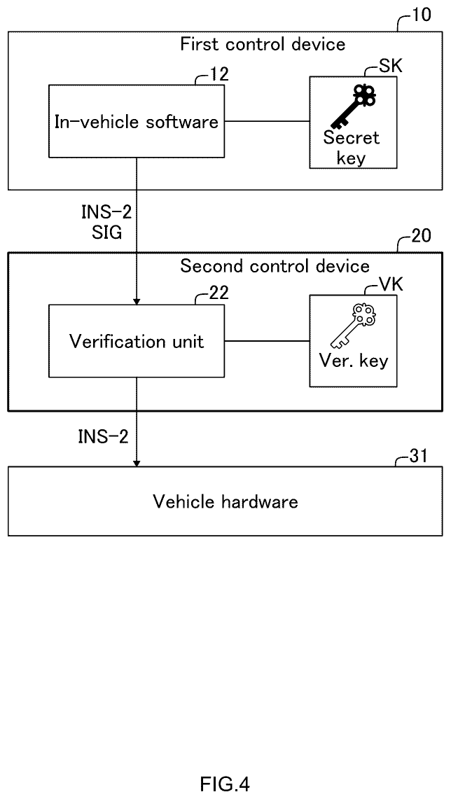

FIG. 4 is a block diagram showing an example of instruction verification in a case where the instruction information INS is an instruction transmitted from the in-vehicle software 12. Hereinafter, such instruction information INS is specifically referred to as in-vehicle instruction information INS-2. The in-vehicle instruction information INS-2 includes a non-traveling instruction that is not directly related to the traveling of the vehicle 30 and a traveling instruction that is directly related to the traveling of the vehicle 30. Examples of the traveling instruction include control values for an accelerator, a brake, a steering, etc. On the other hand, examples of the non-traveling instruction include control values for opening and closing of the doors, turning on a traffic indicator, etc. Hereinafter, the components of the vehicle 30 that can be the targets of the in-vehicle instruction information INS-2, as exemplified here, are referred to as “vehicle hardware 31”.

FIG. 4 shows an example in which the second control device 20 performs the signature verification on the in-vehicle instruction information INS-2. First, the in-vehicle software 12 generates the digital signature SIG of the in-vehicle instruction information INS-2 using the secret key SK. The in-vehicle software 12 transmits the in-vehicle instruction information INS-2 and the digital signature SIG to the verification unit 22 in the second control device 20.

The second control device 20 performs the signature verification on the in-vehicle instruction information INS-2. When the result of the signature verification is valid, the second control device 20 transmits the in-vehicle instruction information INS-2 to the vehicle hardware 31 that is the target of the in-vehicle instruction information INS-2. The vehicle hardware 31 operates in accordance with what the received in-vehicle instruction information INS-2 indicates. On the other hand, when the result of the signature verification is invalid, the second control device 20 rejects the in-vehicle instruction information INS-2, and the in-vehicle instruction information INS-2 is not transmitted to the vehicle hardware 31.

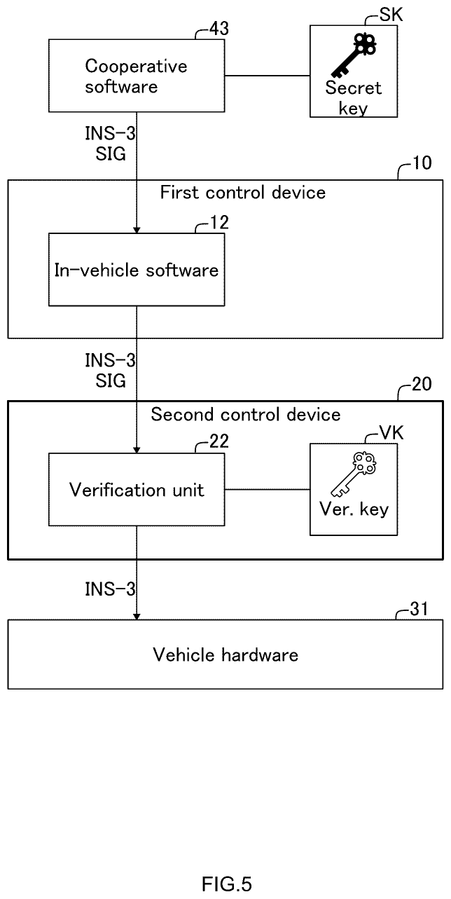

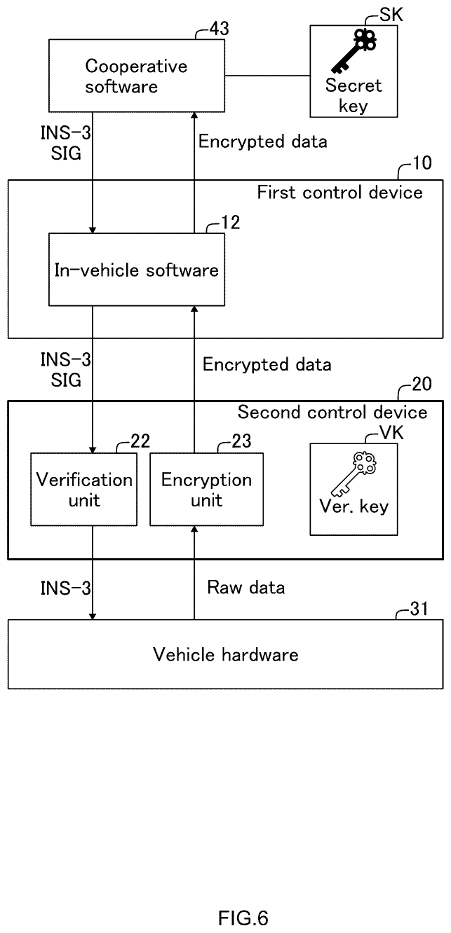

FIGS. 5 and 6 are block diagrams illustrating examples of the instruction verification in cases where the instruction information INS are instructions by the cooperative software 43 cooperating with the in-vehicle software 12. Hereinafter, such instruction information INS is specifically referred to as cooperation instruction information INS-3. Examples of the cooperative software 43 include remote support software that executes remote support for the vehicle 30 and operation management software that is in charge of operation and management of driving services including the vehicle 30. In this case, the in-vehicle software 12 includes agent software that communicates with the cooperative software 43.

In the example of FIG. 5, the content of the cooperation instruction information INS-3 is equivalent to that of the in-vehicle instruction information INS-2. That is, the cooperation instruction information INS-3 also includes an instruction for the vehicle hardware 31. The cooperation instruction information INS-3 is different from the in-vehicle instruction information INS-2 in that the transmission source is the cooperative software 43. The situation illustrated in FIG. 5 corresponds to, for example, a case where the remote support software transmits the content of the remote control for the vehicle hardware 31 as the cooperation instruction information INS-3 to perform the remote support for the vehicle 30. A more specific example is a process of transmitting the steering instruction to the steering of the vehicle 30 when the remote support software steers the vehicle 30.

First, the cooperative software 43 generates the digital signature SIG based on the cooperation instruction information INS-3 and the secret key SK. The cooperative software 43 transmits the cooperation instruction information INS-3 to the in-vehicle software 12 together with the digital signature SIG. The in-vehicle software 12 as a receiver may be agent software corresponding to the cooperative software 43 or may be autonomous driving software, if the first control device 10 includes that. The processes after the in-vehicle software 12 receives the cooperation instruction information INS-3 is the same as those of the in-vehicle instruction information INS-2. That is, the in-vehicle software 12 transmits the cooperation instruction information INS-3 and the digital signature SIG to the verification unit 22 in the second control device 20. Thereafter, the second control device 20 performs the signature verification, and determines whether to transmit the cooperation instruction information INS-3 to the vehicle hardware 31 or reject the cooperation instruction information INS-3 in accordance with the result of the signature verification.

In the example of FIG. 6, the cooperation instruction information INS-3 includes an instruction to request vehicle information. As a specific situation, a situation where the remote support software or the operation management software requires an image of an in-vehicle camera or positional information of the vehicle 30 is exemplified.

The process is the same as that in the example of FIG. 5 until the second control device 20 determines whether to transmit the cooperation instruction information INS-3 to the vehicle hardware 31 or reject the cooperation instruction information INS-3 according to the result of the signature verification. When the second control device 20 determines that the cooperation instruction information INS-3 is valid, the second control device 20 acquires data (raw data) indicated by the cooperation instruction information INS-3 from the vehicle hardware 31. Then an encryption unit 23 of the second control device 20 generates encrypted data using the verification key VK based on the raw data. The encrypted data is transmitted from the second control device 20 to the cooperative software 43 via the in-vehicle software 12. The cooperative software 43 decrypts the received encrypted data using the secret key SK. The pair of the keys for encrypting the raw data and decrypting the encrypted data may be the verification key VK and the secret key SK, used for the signature verification of the cooperation instruction information INS-3, or may be a pair of different keys.

### 2-2. Flow of Instruction Verification

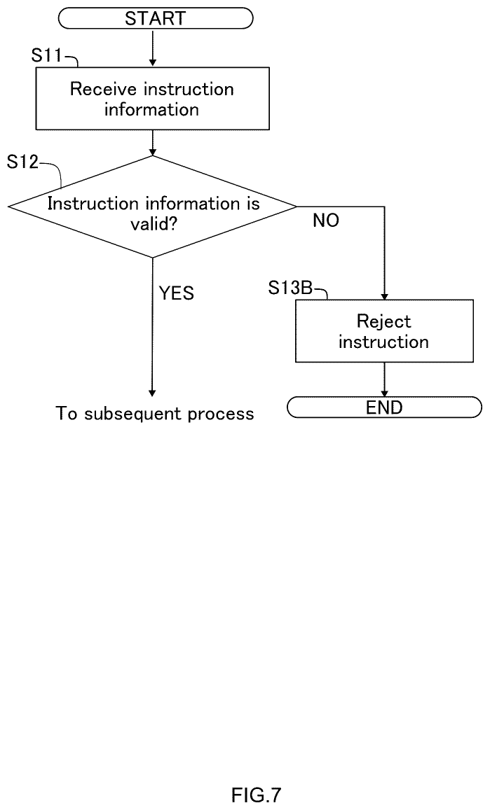

FIG. 7 is a flowchart showing a main flow of process related to the instruction verification.

In step S11, the second control device 20 receives the instruction information INS. The transmission source and the content of the instruction information INS are as described in section 2-1. That is, the instruction information INS includes such as the update data INS-1 of the in-vehicle software 12 transmitted from the distribution server 42, the in-vehicle instruction information INS-2 transmitted from the in-vehicle software 12, and the cooperation instruction information INS-3 transmitted from the cooperative software 43. Thereafter, the process proceeds to step S12.

In step S12, the second control device 20 determines whether or not the received instruction information INS is valid by executing the instruction verification. When the instruction information INS is valid (step S12; YES), the process proceeds to a subsequent process. As described in section 2-1, the subsequent processes includes updating the in-vehicle software 12, controlling the vehicle hardware 31, and acquiring data from the vehicle hardware 31. On the other hand, when the instruction information INS is determined to be invalid (step S12; NO), the process proceeds to step S13B.

In step S13B, the second control device 20 rejects the instruction information INS. No subsequent process is executed in this case. Thereafter, the process is terminated.

### 2-3. Effect

As described in section 1, the vehicle 30 has higher information security than the vehicle 30R of the comparative example, since the vehicle 30 stores the in-vehicle software 12 and the verification key VK in different control devices: the first control device 10 and the second control device 20. That is, when the instruction information INS is invalid, the second control device 20 can appropriately reject the instruction information INS. Therefore, vehicle 30 can reliably prevent intrusion of unauthorized software, unauthorized instruction to the vehicle hardware 31, unauthorized acquisition of vehicle information, etc.

### 3. Application: Vehicle Platform

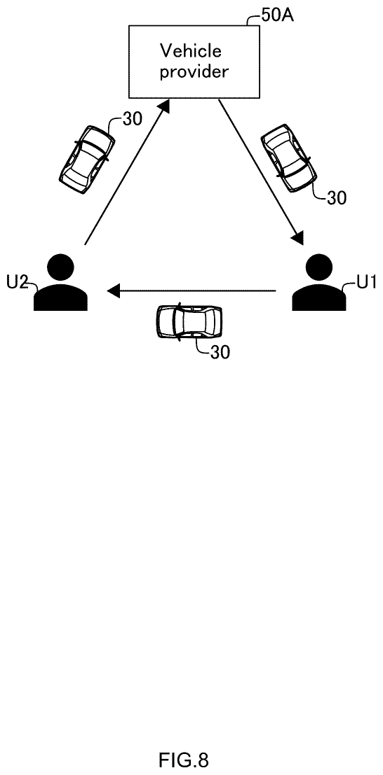

FIG. 8 is a diagram showing the concept of a “vehicle platform” according to the present embodiment. The vehicle platform is a service in which a vehicle provider 50A lends the vehicle 30 to one or more users U (hereinafter, simply referred to as user U). The user U can access the first control device 10 of the rented vehicle 30. Typically, the user U is a software developer, and the user U who has rented the vehicle 30 can write (install) user software 12U, which is his/her own software, in the first control device 10 of the vehicle 30. That is, the user software 12U can be regarded as an example of the in-vehicle software 12. The vehicle provider 50A has permission to access the second control device 20 of the vehicle 30, and the others not. Therefore, the vehicle provider 50A can be regarded as an example of the administrator 50. After being rented to the user U, the vehicle 30 is returned to the vehicle provider 50A. In the example of FIG. 8, the vehicles 30 are rented to the first user U1, and then returned to the vehicle provider 50A, via the second user U2. In this case, each of the first user U1 and the second user U2 can write the user software 12U in the first control device 10. After being returned to the vehicle provider 50A, the vehicle 30 is used for business. An example of the business is a delivery service using an autonomous driving vehicle.

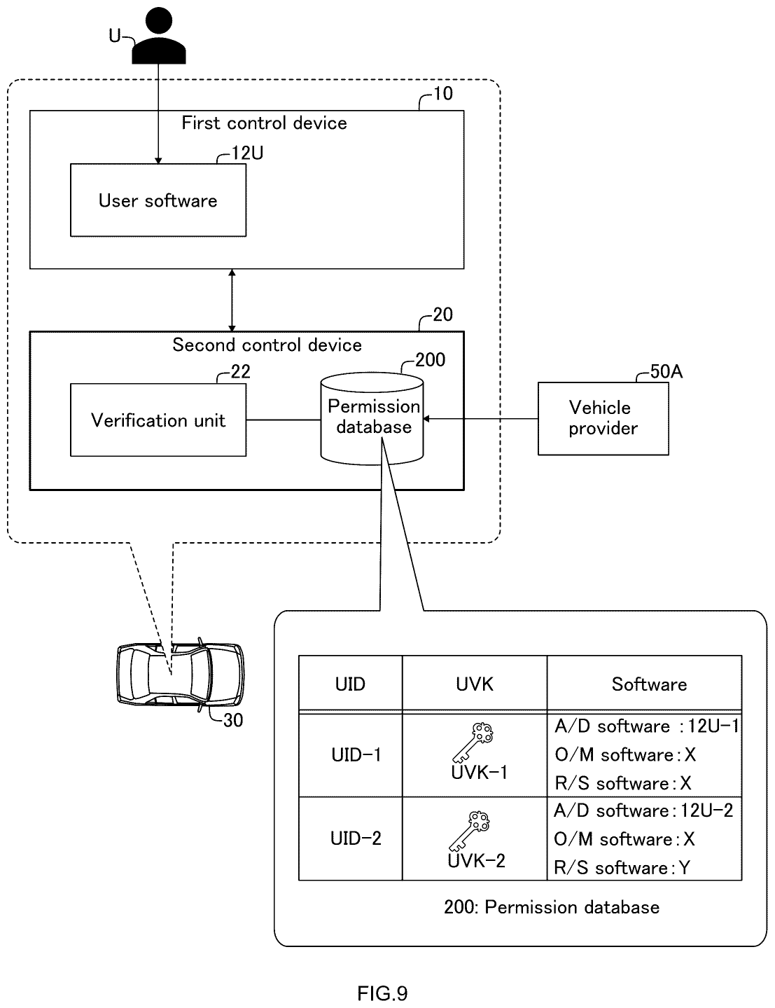

FIG. 9 is a block diagram showing a configuration of the vehicle 30 used in the vehicle platform. The basic configuration is the same as that of the examples described above. In some embodiments, in the case of a vehicle 30 used in a vehicle platform, the verification key VK is managed by the permission database 200. The permission database 200 includes user information UID which is identification information of each user U and a user verification key UVK corresponding to the user information UID. The second control device 20 determines whether or not the user U who attempts to access the first control device 10 of the vehicle 30 has valid access permission. That is, the second control device 20 executes the instruction verification using the user verification key UVK, with the user information UID as the instruction information INS. Hereinafter, the instruction verification performed on the user information UID is specifically referred to as “user verification”. A user U having valid user permission is referred to as an “authorized user”. In other words, the second control device 20 performs the user verification and determines whether or not the user U who attempts to access the first control device 10 is an authorized user.

The permission database 200 shown in FIG. 9 includes the user information UID and the user verification keys UVK for the users U (the first user U1 and the second user U2). The user information UID of the first user U1 and the second user U2 corresponds to first user information UID-1 and second user information UID-2, respectively. The first user information UID-1 and the second user information UID-2 correspond to a first user verification key UVK-1 and a second user verification key UVK-2, respectively. Here, the user U is assumed to be a developer of the autonomous driving software. The user U, who is a developer of the autonomous driving software, can write the autonomous driving software developed by each user as user software 12U in the first control device 10.

The permission database 200 may store information related to the cooperative software 43 corresponding to the user U and the user software 12U. Examples of the cooperative software 43 include the operation management software and the remote support software as described above. In the case of the permission database 200 in FIG. 9, the first user U1 sets software X that collectively executes the operation management and the remote support to cooperate with the first user software 12U-1 provided by the first user U1. The second user U2 sets the operation management function of the software X and the remote support software Y to cooperate with the second user software 12U-2 provided by the second user U-2. The second user software 12U-2 cooperates with the operation management part of the software X, which can collectively execute the operation management and the remote support. The second user software 12U-2 further cooperates with other software (software Y) for the remote support. As described here, each user U can have different combinations of the user software 12U and the cooperative software 43. The permission database 200 may include the verification key VK for each piece of the cooperative software 43 in addition to the user verification key UVK for each user U. “A/D software”, “O/M software”, and “R/S software” in FIG. 9 means autonomous driving software, operation management software, and remote support software, respectively.

### 3-1. User Verification

Some specific examples of the user verification will be described below.

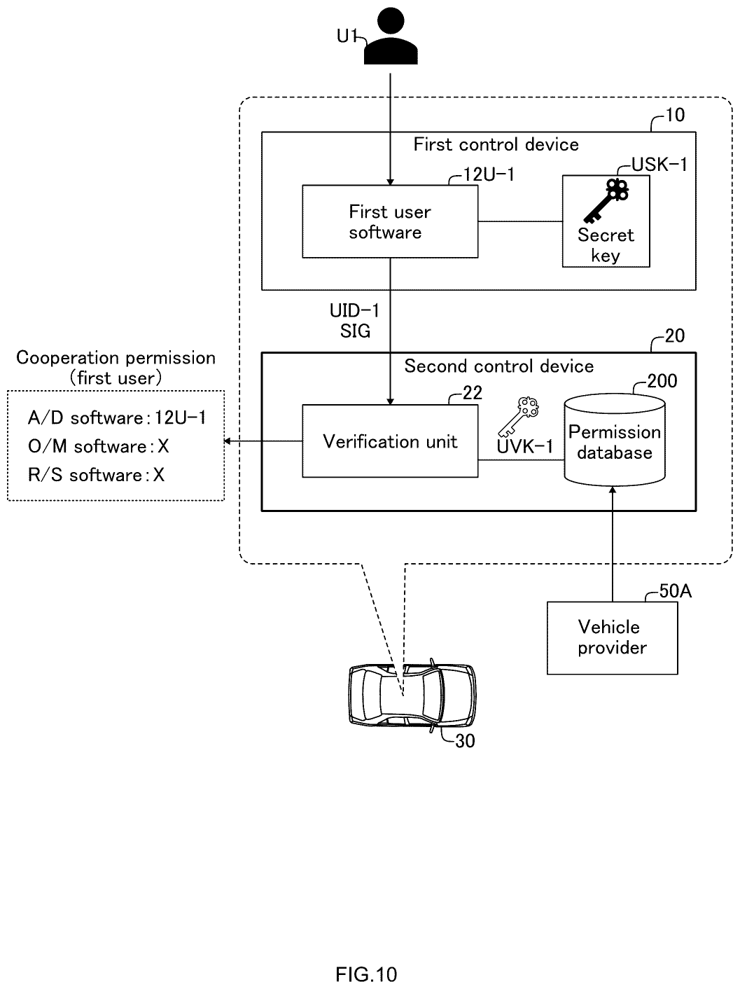

FIG. 10 is a diagram illustrating an example of user verification based on the user information UID transmitted from the in-vehicle software 12. Here, it is assumed that the first user U1 in the permission database 200 of FIG. 9 accesses the first control device 10. The first user U1 instructs the first user software 12U-1 to transmit the first user information UID-1 and the digital signature SIG to the verification unit 22 of the second control device 20. In this case, the digital signature SIG is generated based on the first user information UID-1 and a secret key USK-1.

The second control device 20 performs the instruction verification (the signature verification) on the first user information UID-1. At this time, the second control device 20 verifies the validity of the digital signature SIG with reference to the permission database 200, using the first user verification key UVK-1 corresponding to the received first user information UID-1. When the first user information UID-1 is determined to be valid as a result of the instruction verification, the second control device 20 determines that the first user U1 is an authorized user having valid user authority.

When the first user U1 is determined to be an authorized user, the second control device 20 executes “permission setting”. The permission setting means that permission to access the first control device 10 is given to the cooperative software 43 corresponding to the user software 12U of the authorized user. The content of the permission of the set permission to the cooperative software is referred to as “cooperation permission”. In the example of FIG. 10, the permission setting means that the software X corresponding to the first user U1 is given permission to access the first control device 10 for the purpose of the remote support and the operation management. The cooperation permission indicates the permission to perform the operation management and the remote support given to the software X. When the first user U1 is determined to be an unauthorized user, the second control device 20 rejects the first user information UID-1 and does not execute permission setting.

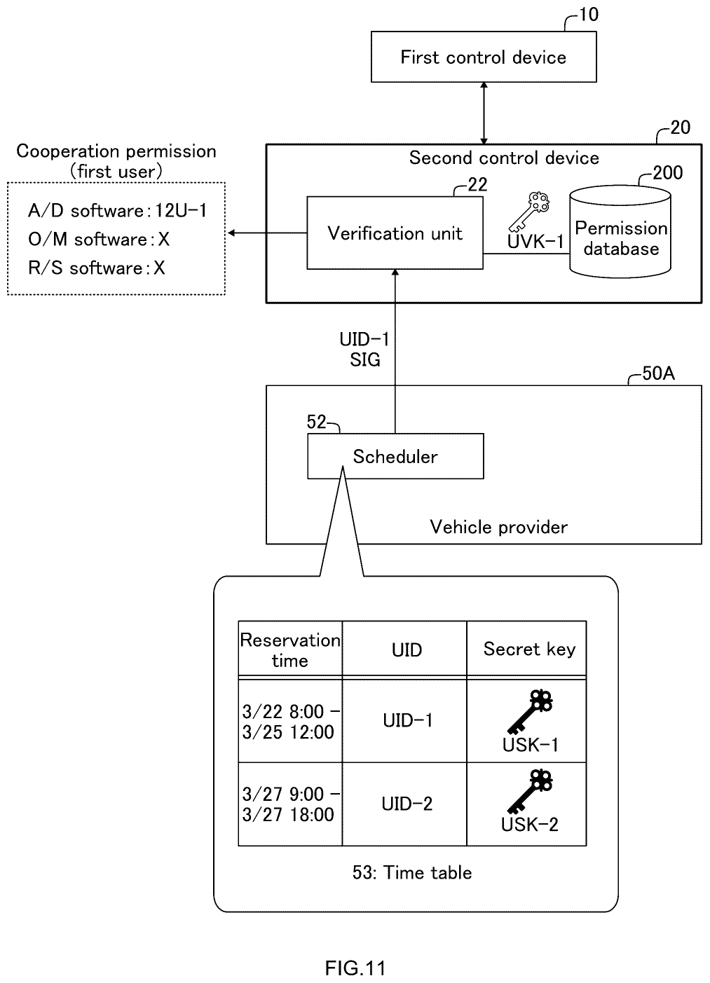

FIG. 11 is a diagram showing an example of user verification in cooperation with a scheduler 52. The scheduler 52 includes a timetable 53 including reservation information related to reservation time of the vehicle 30 by the user U. The scheduler 52 is managed by the vehicle provider 50A. In the case of FIG. 11, the timetable 53 includes reservation information of the first user U1 and the second user U2. When it comes to the reservation time by the first user U1, the scheduler 52 transmits the first user information UID-1 and the digital signature SIG to the verification unit 22 of the second control device 20. The second control device 20 executes the user verification and determines whether or not to execute the permission setting according to its result. The information transmitted from the scheduler 52 may be transmitted to the second control device 20 via the first control device 10.

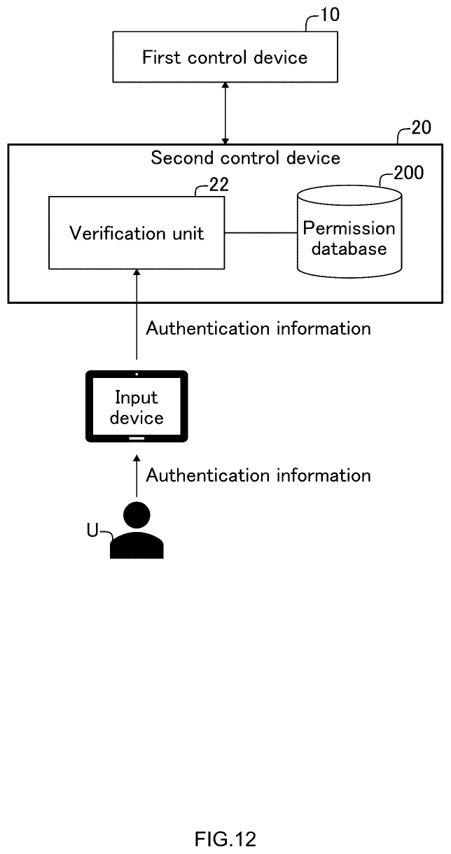

FIG. 12 is a diagram showing an example of a method for authenticating the user U having valid authority without using the user verification key UVK. The user U inputs authentication information using an input device installed in the vehicle 30. Examples of the authentication information include an ID and a password, an IC card, and biometric information (fingerprint, face, etc.). When the user authentication is successful, the second control device 20 executes permission setting.

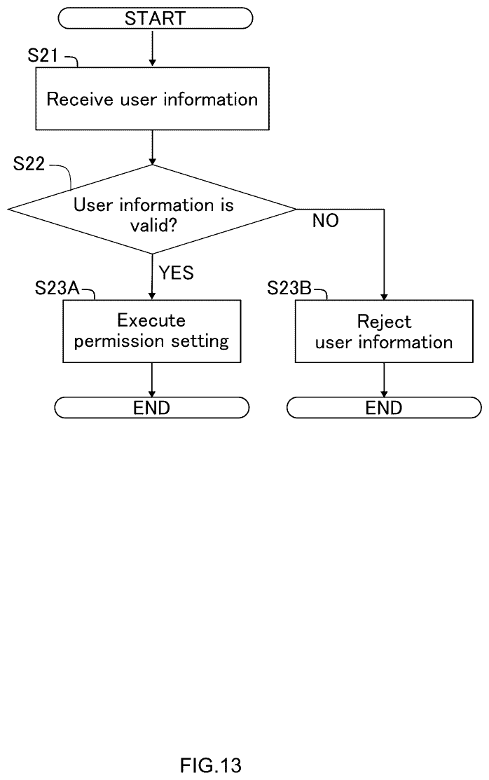

FIG. 13 is a flowchart showing a main flow of process related to the user verification.

In step S21, the second control device 20 receives the user information UID. The transmission source of the user information is the in-vehicle software 12 of the user U or the scheduler 52 as described above. Thereafter, the process proceeds to step S22.

In step S22, the second control device 20 determines whether or not the received user information UID is valid by executing the user verification. When the user information UID is valid (step S22; YES), the process proceeds to step S23A. On the other hand, when the identification information is invalid (step S22; NO), the process proceeds to step S23B.

In step S23A, the second control device 20 executes permission setting related to the authorized user. Thereafter, the process is terminated.

In step S23B, the second control device 20 rejects the user information UID. Thereafter, the process is terminated.

### 3-2. Cooperation Permission for Cooperative Software

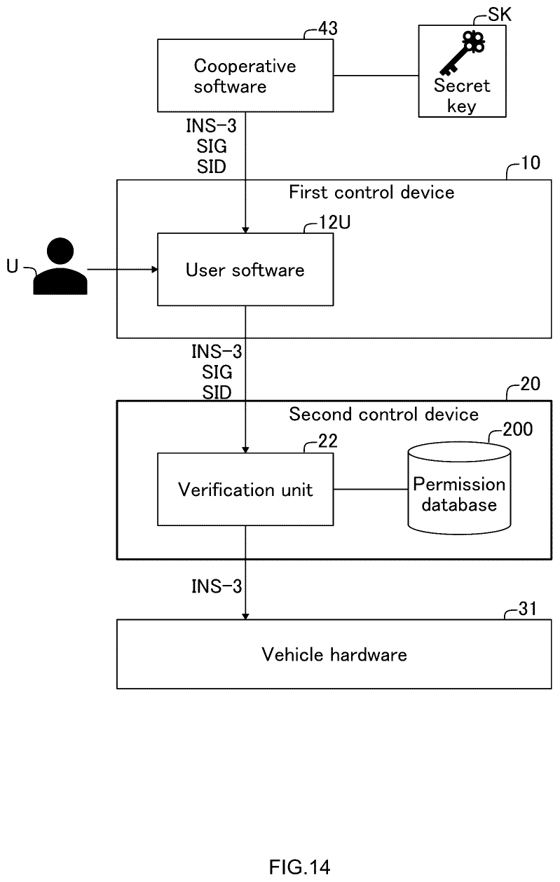

FIG. 14 is a diagram illustrating an overview of the cooperation permission for cooperative software. FIG. 14 corresponds to a case where the verification key VK is managed by the permission database 200 in FIG. 5. It is assumed that the first control device 10 is being accessed by the first user U1 (that is, after the successful user verification of the first user U1). The cooperative software 43 transmits software identification information SID for identifying the cooperative software 43 to the in-vehicle software 12 (the user software 12U) together with the cooperation instruction information INS-3 and the digital signature SIG. The in-vehicle software 12 transmits the software identification information SID, the cooperation instruction information INS-3, and the digital signature SIG to the second control device 20. The second control device 20 executes the instruction verification (the signature verification) on the cooperation instruction information INS-3 and verifies the validity of the cooperation instruction information INS-3.

When the cooperation instruction information INS-3 is valid, the second control device 20 refers to what the cooperation instruction information INS-3 indicates and the content of the cooperation permission of the cooperative software 43 in accordance with the permission setting. When what the cooperation instruction information INS-3 indicates is included in the permissible range indicated by the cooperation permission, the second control device 20 finally determines that the cooperation instruction information INS-3 is valid. The details will be described below with some specific examples.

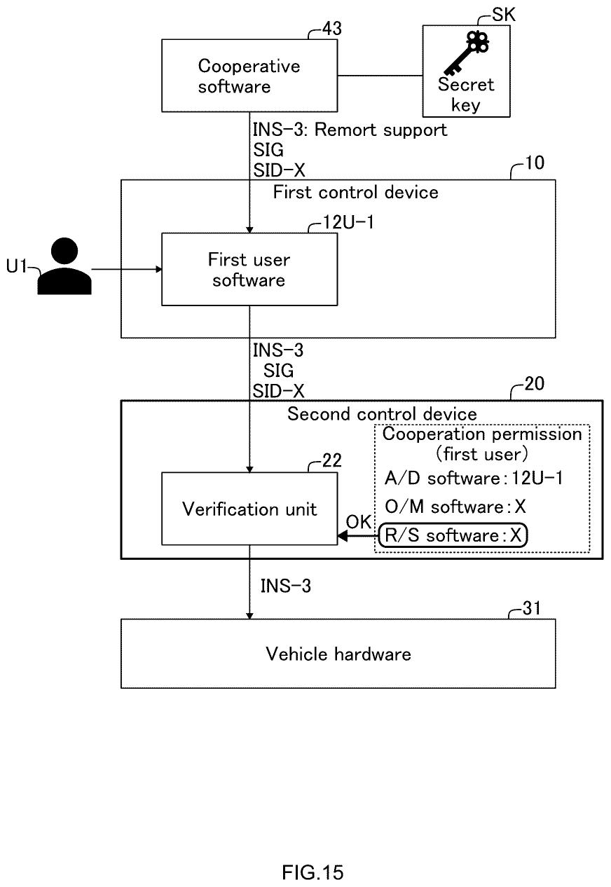

FIG. 15 is a diagram illustrating a specific example of the cooperation permission for the cooperative software 43. As in FIG. 14, the first control device 10 is being accessed by the first user U1. The cooperative software 43 transmits the software identification information SID-X and the cooperation instruction information INS-3 including an instruction associated with remote support (for example, a remote steering instruction). The second control device 20 can determine that the cooperation instruction information INS-3 is actually transmitted from the software X and is not tampered with through the instruction verification. However, whether or not the software X has the permission to perform remote support for the first control device 10 of the vehicle 30 used by the authorized user (here, the first user U1) cannot be determined only by the instruction verification to the instruction information INS. This is because the permission to perform remote support depends on what permission is given to the cooperative software 43. Therefore, it is required to determine “whether or not remote support of the vehicle 30 by the software X is permitted in the access state by the first user U1”. In the case of FIG. 15, the permission database 200 indicates that the software X is given the permission of remote support when the software X is being accessed by the first user U1. Therefore, the second control device 20 finally determines that the cooperation instruction information INS-3 by the software X is valid.

In order to determine whether or not what the cooperation instruction information INS-3 indicates is included in the permissible range of the cooperation permission corresponding to the authorized user, the second control device 20 may use the verification key VK corresponding to each piece of cooperative software 43 stored in the permission database 200.

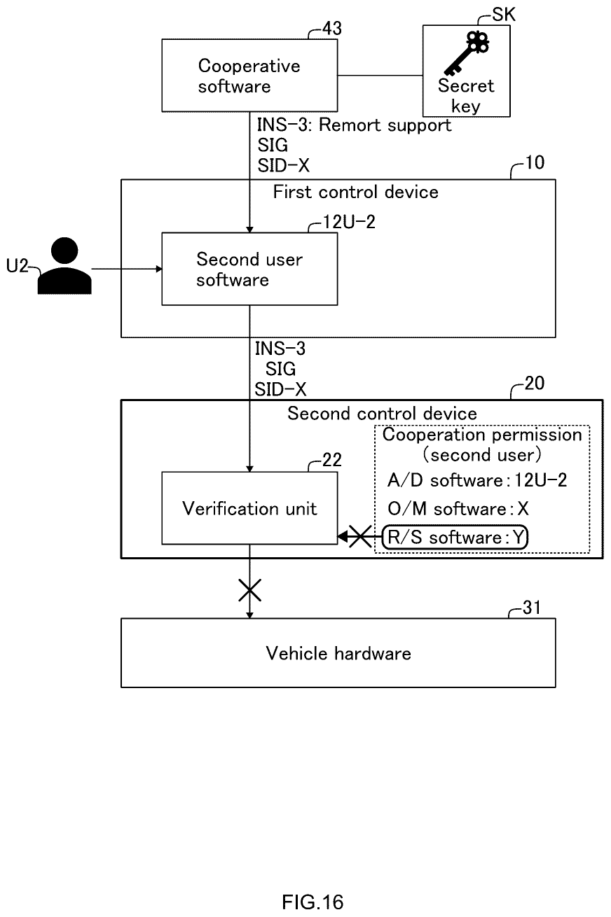

FIG. 16 is a diagram illustrating another specific example of the cooperation permission for the cooperative software 43. The first control device 10 is being accessed by the second user U2. The cooperative software 43 transmits the software identification information SID-X and an instruction associated with remote support as the cooperation instruction information INS-3. In this case, permission database 200 indicates that the permission of the remote support is not given to the software X while the first control device 10 is being accessed by the second user U2. Thus, the cooperation instruction information INS-3 from the software X is rejected.

The cooperation permission may be set per service (for example, overall operation management, overall remote support, permission to acquire an image of an in-vehicle camera, etc.), as illustrated in FIGS. 15 and 16. Alternatively, the cooperation permission may be given per module (individual component such as accelerator control and brake control), more detailed setting than the service level.

### 3-3. Effect of Vehicle in Vehicle Platform

The effect of the vehicle 30 in the case where it is used in the vehicle platform will be described below, compared with the vehicle 30R (comparison example).

When the vehicle 30R shown in the comparison example is used for the vehicle platform, the verification key VK related to the user software 12U written by the user U and the cooperative software 43 is managed in an area accessible by the user U (that is, in one control device). This may cause the following situation. For example, when the first user U1 tries to rewrite the verification key VK related to the first user U1, the first user U1 may intentionally or accidentally rewrite (tamper) the verification key VK related to the second user U2.

As described above, in the vehicle platform, the combination of the cooperative software 43 is typically different between the users U. This means that management of the cooperation permission of each user U would be complicated. Therefore, there is a risk that an instruction by software without cooperation permission is not appropriately rejected.

On the other hand, the vehicle 30 has the in-vehicle software 12 and the verification key VK in the different control devices (i.e., the first control device 10 and the second control device 20). The second control device is designed to be limitedly accessible by the vehicle provider 50A. Therefore, rewriting of the verification key VK of other users does not occur in principle. In addition, since the cooperation permission corresponding to each of the user U is also collectively managed by the vehicle provider 50A, an instruction by software without cooperation permission is appropriately rejected. In conclusion, the vehicle 30 is particularly effective if it is used for the vehicle platform.

### 4. Verification System

The vehicle 30 has been exemplified in the embodiment. However, in addition to vehicles, the technique described in the present disclosure can be widely applied as a verification system to verify instruction information for operating a target device as described below.

The verification system has the following features. The verification system includes a first control device mounted on a target device, which stores software, and a second control device designed to be limitedly accessible by a specific administrator. The first control device and the second control device are configured to communicate with each other. The second control device stores a verification key for verifying the validity of the instruction information and executes instruction verification to verify the validity of the instruction information using the verification key. On the other hand, the first control device does not store the verification key.

The vehicle platform described in the embodiment can also be applied to a target other than a vehicle based on the same configuration. In this case, the “vehicle provider 50A” is replaced with a “provider of the target device”.

What is claimed is:

1. A vehicle comprising:
a first control device including in-vehicle software; and
a second control device designed to be limitedly accessible by a specific administrator, wherein
the first control device and the second control device can communicate with each other,
the second control device is configured to:
store a verification key for verifying validity of instruction information transmitted from outside of the second control device, the verification key being provided from the specific administrator in advance; and
perform instruction verification to verify the validity of the instruction information using the verification key, and
the first control device does not include the verification key.

2. The vehicle according to claim 1, wherein
the second control device is further configured to:
receive the instruction information and a digital signature generated based on a secret key corresponding to the verification key;
execute signature verification to verify validity of the digital signature using the verification key; and
determine that the instruction information is valid when determining that the digital signature is valid.

3. The vehicle according to claim 1, wherein
the instruction information includes data instructing to update the in-vehicle software to be distributed to the vehicle.

4. The vehicle according to claim 1, wherein
the instruction information includes in-vehicle instruction information indicating an instruction transmitted from the in-vehicle software to hardware of the vehicle.

5. The vehicle according to claim 1, wherein
the instruction information includes cooperation instruction information indicating an instruction transmitted to the in-vehicle software from cooperative software cooperating with the in-vehicle software.

6. The vehicle according to claim 1, wherein
the in-vehicle software included in the first control device is designed to be rewritable by one or more users, and
the specific administrator includes a vehicle provider that provides the vehicle to the one or more users.

7. The vehicle according to claim 6, wherein
the second control device is further configured to store user information for identifying each of the one or more users,
the instruction information includes first user information transmitted to the second control device when a first user of the one or more users accesses the first control device, and
the second control device is further configured to:
execute user verification that is the instruction verification for the first user information based on the user information; and
determine that the first user is an authorized user with valid access permission when determining that the first user information is valid.

8. The vehicle according to claim 7, wherein
the instruction information further includes cooperation instruction information indicating an instruction transmitted to the in-vehicle software from cooperative software cooperating with the in-vehicle software, and
the second control device is further configured to:
store information of cooperation permission for each of the one or more users, the cooperation permission indicating a permissible range of cooperation between the cooperative software and the in-vehicle software; and
set the cooperation permission corresponding to the authorized user after the user verification.

9. The vehicle according to claim 8, wherein
in a case where the first control device is being accessed by the authorized user and the in-vehicle software receives the cooperation instruction information, the second control device is further configured to determine that the cooperation instruction information is valid when the cooperation instruction information is determined to be valid in the instruction verification and a content of the cooperation instruction information is included in the permissible range indicated by the cooperation permission corresponding to the authorized user.

10. A verification system for verifying instruction information for operating a target device, the verification system comprising:
a first control device, including software, provided with the target device; and
a second control device designed to be limitedly accessible by a specific administrator, wherein
the first control device and the second control device can communicate with each other,
the second control device is configured to:
store a verification key to verify validity of instruction information transmitted from outside of the second control device, the verification key being provided from the specific administrator in advance; and
perform instruction verification to verify the validity of the instruction information using the verification key, and
the first control device does not include the verification key.

11. The verification system according to claim 10, wherein
the software included in the first control device is designed to be rewritable by one or more users, and
the specific administrator includes a provider of the target device that provides the target device to the one or more users.

12. The verification system according to claim 11, wherein
the second control device is further configured to store user information for identifying each of the one or more users,
the instruction information includes first user information transmitted to the second control device when a first user of the one or more users accesses the first control device, and
the second control device is further configured to:
execute user verification that is the instruction verification for the first user information based on the user information; and
determine that the first user is an authorized user with valid access permission when determining that the first user information is valid.

13. The verification system according to claim 12, wherein
the instruction information further includes cooperation instruction information indicating an instruction to be transmitted to the software from cooperative software cooperating with the software, and
the second control device further configured to:
store information of cooperation permission for each of the one or more users, the cooperation permission indicating a permissible range of cooperation between the cooperative software and the software; and
set the cooperation permission corresponding to the authorized user after the user verification.

14. The verification system according to claim 13, wherein
in a case where the first control device is being accessed by the authorized user and the software receives the cooperation instruction information, the second control device is further configured to determine that the cooperation instruction information is valid when the cooperation instruction information is determined to be valid in the instruction verification and a content of the cooperation instruction information is included in the permissible range indicated by the cooperation permission corresponding to the authorized user.
